(19) United States
(12) Patent Application Publication
(10) Pub. No.: US 2010/0220592 A1
(43) Pub. Date: Sep. 2, 2010

(54) LAYERED INTERNET VIDEO ENGINEERING

(75) Inventors: Rong Pan, Sunnyvale, CA (US); Xiaoqing Zhu, Nanjing (CN); Nandita Dukkipati, Menlo Park, CA (US); Vijaynarayanan Subramanian, Sunnyvale, CA (US)

Correspondence Address: MERCHANT & GOULD;SCIENTIFIC ATLANTA, A CISCO COMPANY, P.O. BOX 2903, MINNEAPOLIS, MN, 55402-0903, US

(73) Assignee: Cisco Technology, Inc., San Jose, CA (US)

(21) Appl. No.: 12/711,999

(22) Filed: Feb. 24, 2010

Related U.S. Application Data
(60) Provisional application No. 61/154,966, filed on Feb. 24, 2009.

(51) Int. Cl. H04L 12/56

(52) U.S. Cl. 370/232

(57) ABSTRACT

Embodiments are described herein such as a method for providing media-aware congestion control for the transmission of video streams, the method comprising: estimating congestion price information for one or more network nodes; responding to the congestion price information by calculating optimal rates for one or more end hosts; adapting the sending rates of the one or more end hosts according to the calculated optimal rates; and determining an amount of FEC to be inserted into the video streams based on the congestion price information.

### FIELD OF THE DISCLOSURE

The present disclosure relates to a congestion control scheme for the transmission of video.

### BACKGROUND

As video traffic increases in the Internet and competes for limited bandwidth resources, congestion control schemes may be needed that account for video characteristics and go beyond the traditional paradigm of fair-rate allocation for data traffic to handle both persistent and transient congestion as video streaming applications demand low latency transmissions and low packet losses ratios.

### BRIEF DESCRIPTION OF THE DRAWINGS

Many aspects of the disclosure can be better understood with reference to the following drawings. The components in the drawings are not necessarily to scale. Emphasis is instead placed upon clearly illustrating the principles of the present disclosure.

FIG. 1 illustrates a network diagram according to embodiments of the invention.

FIG. 2 illustrates the difference between conventional congestion control schemes and embodiments of congestion control schemes of the present invention.

FIG. 3 illustrates dynamics of the media-aware congestion control scheme according to embodiments of the invention.

FIG. 4 illustrates the relationship between the price difference and the FEC percentage in embodiments of the present invention.

FIG. 5 illustrates the incoming traffic rate, queue size and congestion price at the bottleneck link, as well as the recommended FEC protection percentage for each stream according to embodiments of the present invention.

FIG. 6 provides an illustration of the GOP structure in a H.264/SVC stream with quality and temporal scalability.

FIG. 7 shows network simulation topologies for embodiments of the present invention.

FIG. 8 illustrates the rate-distortion tradeoff for three 4CIF video sequences used in testing embodiments of the present invention.

FIG. 9 illustrates testing results for embodiments of the present invention.

FIG. 10 shows traces of heuristics associated with embodiments of the present invention.

FIG. 11 further compares embodiments of the adaptive FEC scheme in the present invention against two other heuristics operating at extreme measures.

FIG. 12 shows traces of heuristics associated with embodiments of the present invention.

FIG. 13 shows traces of heuristics associated with embodiments of the present invention.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

Video traffic has been growing rapidly for the past few years and is becoming an important part of the Internet. For example, a recent report shows that Internet video was 21% of all consumer Internet traffic in 2007, and will reach 31% by the end of 2008, and is expected to account for nearly 50% of all consumer Internet traffic in 2012. (The definition of Internet video does not include that amount of video exchanged through P2P file sharing).

As more and more video flows compete for network resources, congestion may inevitably lead to packet delays or drops at network nodes. Both delayed and lost video packets could introduce severe degradation of users' experience. Hence, there is a pressing need to design new congestion control and transient error protection schemes that may be tailored to video traffic.

TCP friendliness and smooth rate control systems, such as TCP Friendly Rate Control (TFRC) detect network congestion through packet losses and delays which may be often difficult to measure accurately and quickly. As a result, these systems may be less responsive to short term network changes.

Some systems may adopt the max-min fairness or proportional fairness notion for allocating rates for video traffic. However, fairness in rates does not necessarily mean better video quality to users. More bandwidth allocated to Standard Definition (SD) videos might be wasted as their viewers might not detect any quality difference; while High Definition (HD) videos could use the extra bandwidth for enhanced-layer traffic. Embodiments of the invention adopt the Rate-Distortion (R-D) function as users' utility function can reduce greatly undesirable quality fluctuations during video streaming and describes a control scheme that combines congestion pricing at network nodes with the R-D utility function at traffic sources.

The current practice of video rate adaptation relies on either bitstream switching, or pruning packets from a non-scalable video stream. The former approach may require extra storage space on video servers; whereas the latter may incur significant degradation in received video quality. As an alternative, the Scalable Video Coding (SVC) extension of the H.264 standard may provide a more flexible framework for video rate adaptation. SVC introduces a layered representation of video information: a minimum video quality may be provided by base layer packets, whereas enhancement layer packets for video quality improvements can be stripped or added on the fly according to network conditions.

Video applications typically have stringent packet delivery delay budgets and may be sensitive to packet losses, therefore it's preferable to keep the network queues nearly empty. Conventional reactive congestion control schemes such as TCP may be reactive in nature, in that they infer congestion from packet drops or marks as signals to cut rates, resulting in standing queues at network nodes. A congestion control mechanism may be desired that does not rely on packet losses or queuing delays as congestion indication.

When streaming video content over a best-effort network such as the Internet, it may be desirable to adapt the video source rate on-the-fly according to time-varying available bandwidth. Scalable video coding may provide an elegant solution to the rate adaptation problem. The encoded video bitstream can be decoded partially at several different target rates, offering a range of rate-distortion tradeoff points. This feature may be supported both by the fine granularity scalability (FGS) extension in MPEG-4 and by the scalable video coding (SVC) extension in H.264. While FGS in MPEG-4 may provide the desired capability of fine rate tuning, it may suffer from substantially inferior rate-distortion performance with respect to non-scalable video coding. The SVC extension in H.264, on the other hand, succeeds in achieving rate-distortion performance comparable to its non-scalable counterpart H.264/AVC by adopting motion-compensated lifting for temporal prediction without abandoning the well-engineered hybrid block-based coding structure.

The current Internet may provide a connectionless, best-effort service. It relies on transport layer protocols such as TCP to provide a reliable service even under heavy load. Improving congestion control in TCP may be generally divided into two approaches: implicit and explicit signaling. Implicit-signaling protocols may deduce congestion from packet losses or delays, for instance TCP Reno and BIC. Explicit signaling protocols may use additional header fields to allow network nodes to specify congestion levels or rates directly, such as MaxNet and RCP.

An example of congestion control with Internet video may be TFRC, which may adopt implicit signaling and allocates video rates in compliance with rates of TCP flows while avoiding the typical sawtooth fluctuations in TCP. However, it may be less responsive to short term network changes. A Rate-Distortion (R-D) framework may reduce undesirable quality fluctuations during streaming. However, it may stop short of designing a control scheme that combines congestion pricing at network nodes with the R-D utility function at traffic sources.

Forward Error Correction (FEC) may be incorporated for video streaming over best-effort networks in embodiments of the present invention. An error resilient coding scheme may be proposed in using FEC by virtually increasing the size of a group of pictures (GOP) by one frame. An adaptive FEC coding technique may be applied to address throughput fluctuations inherent in TCP video streaming caused by TCP's window oscillations. A new congestion window technique may optimize the extra bandwidth needed for FEC. The FEC overhead rate may effect the performance of scalable video streaming. Proper control of FEC overhead can significantly improve the utility of received video over lossy channels.

Embodiments of the invention may describe a system where end hosts respond to network conditions by adapting their rates based on their video rate-distortion (R-D) characteristics. The congestion information may be used to calculate the amount of Forward Error Correction (FEC) protection needed to combat transient losses. The total distortion of all video streams sharing a common bottleneck may be minimized. The use of an adaptive FEC may be effective with low overhead, and may be stable for any number of streams with arbitrary round trip times below a prescribed limit.

Embodiments of the invention may combine network intelligence with video applications' rate adaptation capability. These embodiments may incur low loss rates and end-to-end delays under persistent congestion. Given traffic bursts which can occur under various conditions, video packets may be protected with on-demand FEC. These embodiments may be stable for any number of streams with arbitrary round trip times below a prescribed limit. Furthermore, all the information updates may be done in long intervals where high speed computations may not be needed.

Embodiments of the invention provide an effective congestion control and error protection scheme. First, video streaming rates may be adapted to the time-varying available bandwidth of a congested network. Second, network nodes such as switches and routers may play a proactive role in congestion control and transient error protection for Internet video. In addition, when multiple streams compete for a single network resource, their relative quality may be balanced while achieving maximum efficiency. The same rate translates to different utility for different streams, depending on their content complexity, coding structure, etc. Hence, each stream's utility function may be taken into account and may adapt its rate accordingly. As a result, the fairness notion may not be max-min or proportional fairness as generally adopted by traditional data applications. Rather, the total video distortion of all streams may be minimized while striving for full utilization of the link capacities.

Embodiments of the invention may protect video traffic. A robust congestion control scheme that combines network intelligence with video applications' rate adaptation capability can provide low packet loss rate and end-to-end delay under persistent congestion. However, networks may be frequently in a state of flux. Traffic bursts can occur when new flows join in, when routes change due to link failures, or even when existing flows ramp up after an idle period. Whatever the underlying reason, transient events may cause buffers to fill and eventually overflow, resulting in packet losses and causing substantial quality degradation in received videos. While retransmission can recover lost packets in TCP flows, it may introduce additional latency for streaming video.

Embodiments of the invention may therefore use Forward Error Correction (FEC) to recover any unexpected packet losses. Applying FEC together with congestion control may be a delicate act: either the amount of FEC may be insufficient when congestion happens, or the added FEC may be wasted when no congestion exists. However, if network nodes take a proactive role in congestion control, embodiments of the invention may anticipate congestion and insert FEC as needed. In this way, the benefits of FEC may be preserved without wasting network bandwidth.

In embodiments of the invention, network nodes may play a proactive role by explicitly signaling their congestion levels. SVC traffic sources may respond to such information by adapting their sending rates based on both the congestion level and the rate-distortion functions. In addition, SVC traffic sources may also determine the amount of FEC needed in order to protect video packets given the congestion conditions. The final video streaming rate may be chosen according to both recommendations. The rest of the rate budget may then be padded with FEC parity packets. This may result in outperforming fair-rate allocation in terms of video quality for all streams that share a common bottleneck. On-demand FEC can protect video packets from transient losses without wasting too much network bandwidth. The system may then be stable for any number of video streams with arbitrary round trip times below a prescribed limit.

Embodiments of the invention may include intelligent network nodes which estimate their congestion pricing information and end hosts which respond to congestion information by adapting their sending rates according to rate-distortion functions. The same congestion information may also be used to determine the amount of FEC to be inserted into video streams. The final streaming rate may then contain two components: SVC video data and FEC redundant data. Embodiments of the invention combine media-aware congestion control with adaptive FEC protection against transient errors for scalable video streaming.

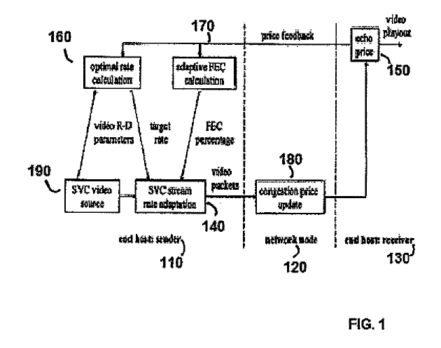

FIG. 1 illustrates a network diagram according to embodiments of the invention. Each video packet initially provided by SVC video source 190, may carry a header field into which a network node, such as network node 120 can insert its congestion information using a congestion price update module 180. This congestion information field may be initialized to zero at a sender 110 and can be modified by any network node 120 if its congestion price greater than the one already in the header. By the time a packet reaches an end host receiver 130, its header carries the maximum congestion price along the forward path. Receiver 130 then may echo this information back to sender 110 in the video acknowledgement (ACK) packet header using a echo module 150.

The congestion price may then used at sender 110 to calculate both the optimal rate based on the video R-D parameters at calculator module 160 and to calculate recommended FEC protection percentage against transient congestion errors at calculator module 170. The SVC stream rate adaptation module 140 may combines the information provided from calculator module 160 and calculator module 170 to determine the maximum SVC rate point allowed and to pad the rest of the rate budget with FEC protection. Both SVC video packets and FEC parity packets may then be sent out at the optimal rate.

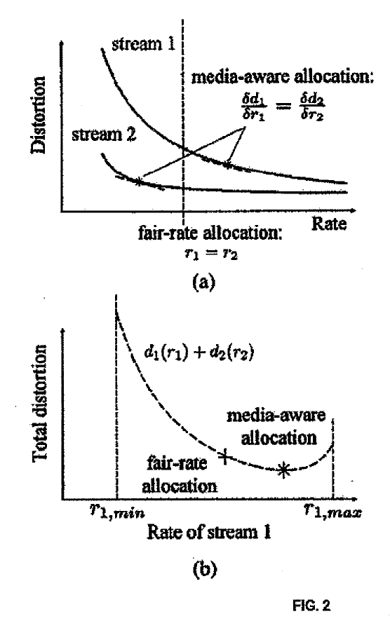

FIG. 2 illustrates the difference between conventional congestion control schemes and embodiments of congestion control schemes of the present invention. Conventional control schemes may typically aim at allocating fair rate among competing flows with the underlying assumption that they bear the same utility function. Embodiments of the invention may perform congestion control in a media-aware fashion, by adapting allocated rate to each video stream according to its R-D characteristics. As the fair-rate allocation will arrive at r₁=r₂ for two competing streams with different R-D curves such as stream 1 and stream 2, the resulting video distortion may be excessively high for the more complex stream 1 and unduly low for the less demanding stream 2. This leads to suboptimal total distortion of both streams in comparison with media-aware allocation.

Graph (b) illustrates the total distortion for both stream 1 and stream 2. The media-aware approach illustrated in graph (b) may achieve minimum total distortion by choosing an allocation that satisfies the Pareto optimality condition δd₁/δr₁=δd₂/δr₂ while meeting the same total rate constraint as in the fair-rate allocation. In this work, the parametric model for characterizing video R-D tradeoff curves is adopted:

$$d = {d}^{0} + \frac{θ}{r - {r}^{0}} . \qquad ( 1 )$$

The parameters d⁰, r⁰ and θ may be fitted from empirical R-D points of the pre-encoded video stream for every GOP.

In embodiments of the invention, media-aware congestion control schemes may involve congestion price update at network nodes and video rate adaptation at end hosts. The scheme may be distributed in nature: network nodes do not necessarily need video R-D information, and the video end hosts request only minimal congestion information from the network, i.e., the maximum congestion price along its path.

A network node may compute its congestion price based on how much the arrival rate exceeds its target link utilization over a time interval. The network node may insert this information into packet headers. Note that the choice of a target link utilization below unity allows congestion to be predicted early rather than to be reacted upon. As a result, there may be no standing queue even under persistent congestion, which may be a QoS feature for video streaming traffic. The congestion price update equation applied in embodiments of the invention is:

$${q}_{l} ( t ) = {q}_{l} ( t - τ ) + κ \frac{{y}_{l} ( t ) - γ {c}_{l}}{{c}_{l}} τ , \qquad ( 2 ) .$$

with parameters:
qₗ(t): congestion price at time t;
yₗ(t): traffic arrival rate at time t;
cₗ: outgoing link capacity;
τ: price update interval;
κ: scaling factor for price update;
γ: target utilization.

Since the network nodes may only perform the congestion price update above once every time interval τ, the extra processing burden imposed on the network switches or routers may be quite light. Upon receiving the video ACK packet whose header carries the maximum congestion price along its path, the sender of each stream i may recalculates the optimal target video rate as:

$$\begin{matrix}{p}_{i} ( t ) = {\tilde{q}}_{i} ( t ) + α \frac{( {\tilde{q}}_{i} ( t ) - {\tilde{q}}_{i} ( t - {τ}_{i} ) )}{{τ}_{i}} , & ( 3 ) \\ {r}_{i}^{*} ( t ) = {r}_{i}^{0} + \sqrt{\frac{{θ}_{i}}{{p}_{i} ( t )}} , & ( 4 ) \\ {r}_{i} ( t ) = \frac{{r}_{i}^{*} ( t ) - {r}_{i} ( t - {τ}_{i} )}{η {\tilde{τ}}_{i}} , & ( 5 )\end{matrix}$$

with parameters

q̅ᵢ(t): the maximum price along the path at time t;

pᵢ(t): current price projection at time t;

r*ᵢ(t): target video rate at time t;

rᵢ(t): optimal rate at time t;

θᵢ, rᵢ⁰: video R-D parameters;

τᵢ: interval from last rate update;

τ̅ᵢ: estimated round trip time;

α: parameter for price prediction;

η: scaling factor for rate update.

In (3), the current price used by the video source for rate adaptation pᵢ(t) may be predicted from the past sample q̅ᵢ(t−τᵢ) and the freshly received sample q̅ᵢ(t) to compensate for the impact of delayed observations. The target optimal rate may then be calculated according to (4) based on the video R-D model from (1). Streams with long RTTs tend to respond to congestion changes slowly, hence they may need to take smaller update steps in approaching the target r*ᵢ(t), by following the update equation (5). This last step avoids big rate swings and ensures system stability, as stated below.

For example, let rttₘₐₓ be the maximum round trip time in the system; (dₘᵢₙ be the minimum distortion and rₘₐₓ be the corresponding maximum rate of a video stream in the system. Assume α>>rttₘₐₓ and η>>1. If:

$$κ < \frac{π η ( {d}_{min} - {d}^{0} )}{γ α ( {r}_{max} - {r}^{0} )} , \qquad ( 6 )$$

then the overall feedback system may be stable for any number of streams with round trip times less than rttₘₐₓ.

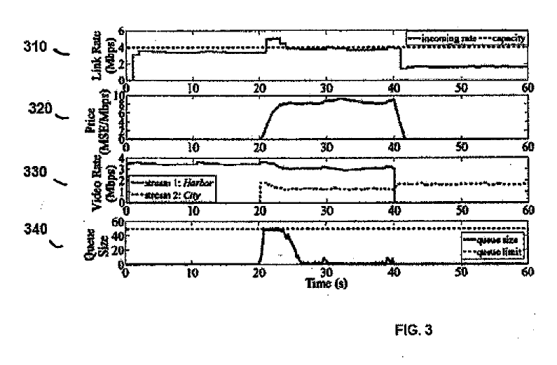

FIG. 3 illustrates dynamics of the media-aware congestion control scheme according to embodiments of the invention. Traces may be performed of total traffic rate on the bottleneck link yᵢ(t) 310, corresponding congestion price pᵢ(t) 320, allocated video rate at the end host rᵢ(t) 330 and queue size in terms of number of packets 340, when two video streams with different content, entitled Harbor (stream 1) and City (stream 2), share a bottleneck link with capacity 4 Mbps.

Initially when only Harbor is active, the maximum rate of the SVC stream may be lower than target utilization, therefore the congestion price remains at zero and the stream may be delivered at full rate and quality. When the City stream enters the network at time t=20 seconds, it may introduce transient congestion over the network. The instantaneous traffic rate over the link may exceed link capacity, leading to a sharp increase in the congestion price, which can drive the rate of both streams lower.

It can be noted at 330 that Harbor continues to stream at a higher rate than City, due to its more demanding R-D characteristic. When. Harbor finishes streaming at time t=40 seconds, the congestion price drops quickly back to zero, thereby allowing the remainder of City to stream at the maximum rate and quality.

Adaptive FEC: Protecting Transient Congestion To protect video streams against transient network congestion, a solution may be to always add a fixed amount of FEC. However, this approach may unnecessarily take bandwidth away from the video stream during steady states when there may be little or no congestion. Instead, embodiments of the invention employ price feedback information and may introduce FEC protection adaptively. The amount of FEC may be increased in the face of consistently rising price, and FEC protection may be abandoned when price decreases. The adapted amount of FEC increases the level of recovery of video packets, while minimizing the amount of wasted FEC that may unnecessarily eat away from a video rate budget.

Embodiments of the invention may apply (n, k) Reed-Solomon (RS) erasure codes across k video packets within each frame to generate n−k parity packets. The parameters n and k may be adjusted on the fly for each video frame based on past and current congestion price observations. This ensures protection against any n−k lost packets within the same frame, with an overhead ratio of (n−k)/n. The additional delay introduced by such protection may be on the order of video frame intervals. The use of RS code in embodiments of the invention may be mainly due to its optimality and popularity for erasure protection; the adaptive algorithm may be general enough to accommodate other FEC coding schemes, such as fountain codes or other suitable codes.

The adaptive FEC algorithm in embodiments of the invention works as follows: the FEC protection percentage fₐ may be calculated from the congestion price feedback information for each stream i. An increase in congestion price may serve as an early indication of impending queue rise, and so fₐ increases linearly with an increase in congestion price. In addition, the value of fₐ may be capped below and above by fₘᵢₙ, and fₘₐₓ. This can also be expressed as follows:

$${f}_{a} = \{ \begin{matrix}0 , & Δ {\tilde{q}}_{i} < 0 \\ {f}_{max} , & Δ {\tilde{q}}_{i} > {\tilde{q}}_{max} \\ \frac{Δ {\tilde{q}}_{i}}{Δ {\tilde{q}}_{max}} {f}_{max} , & otherwise ,\end{matrix} \qquad ( 7 ) .$$

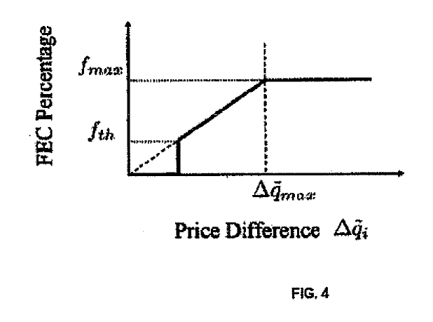

FIG. 4 illustrates the relationship between the price difference and the FEC percentage in embodiments of the present invention. In (7), Δ q̅ᵢ, may be the difference between two samples of congestion price observed at the end host. The illustrative time interval between the two observations to be 200 ms. This relatively large interval avoids reacting incorrectly to possible local price fluctuations due to incoming traffic bursts at sub-RTT level. Δ q̅ₘₐₓ may be the price difference value at which embodiments of the invention may respond with full level of FEC protection. The value of Δ q̅ₘₐₓ may be chosen empirically by learning from RTT statistics. In embodiments of the invention, Δ q̅ₘₐₓ may corresponds to an oversubscription limit at the bottleneck queue by 50% of link capacity for the entire observation interval.

Embodiments of the invention may incorporate additional heuristics. A dead-zone of 5% may be employed to reduce false alarms, i.e. no FEC packets may be injected unless the recommended amount may be greater than a pre-determined threshold, such as 5%. If the recommended FEC amount suddenly falls to zero, the scheme holds on to the last positive value for at least three RTTs before following the recommendation. Since a newly starting stream would almost surely build up a transient queue before the price settles at a new equilibrium, the adaptive scheme also dictates full FEC protection for the first five RTTs when a stream initially starts.

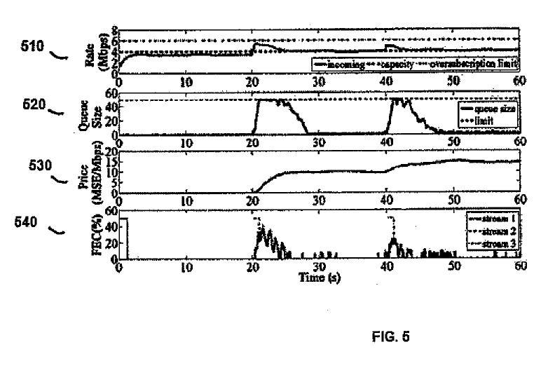

FIG. 5 illustrates the incoming traffic rate 510, queue size 520, and congestion price 530 at the bottleneck link, as well as the recommended FEC protection percentage 540 for each stream according to embodiments of the present invention. Stream 1 may enter an empty link with capacity of 4 Mbps at time t=0 s, while Stream 2 and 3 may start at t=20 s and t=40 s. When a new stream enters the network, the queue at the bottleneck link may overflow and all streams lose a fraction of their packets. Note that FEC amount increases steeply in response to the rising price when a new stream joins the network. As a result, in the example, 99.67%, 99.68% and 100% of video frames from the three streams may be recovered, respectively, thus incurring very few false positives.

SVC Rate Adaptation Subsequent to calculating the optimal rate from media-aware congestion control and the amount of FEC needed for transient error protection, embodiments of the invention may determine the SVC rate adaptation to base the calculation on. In this work, video streaming with pre-encoded contents may be considered. Under H.264/SVC, each video frame may be encoded into multiple video packets corresponding to multiple quality layers. The video packets may be classified as base layer (BL) and enhancement layer (EL) packets. In addition, the video frames may be organized into multiple temporal layers, in that an encoded video frame from temporal layer m+1 may be bi-directionally predicted from adjacent reconstructed video frames from temporal layer m.

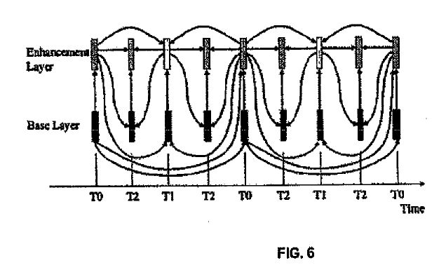

FIG. 6 provides an illustration of the GOP structure in a H.264/SVC stream with quality and temporal scalability. In the illustrated example, the GOP length is four frames, corresponding to three temporal layers. On-the-fly rate adaptation may be possible by omitting EL packets starting from frames with highest temporal layers. Note that a stream with M temporal layers may be streamed at M+1 alternative rate points. The continuous video R-D parametric curves may be fitted from a discrete set of available rates and qualities, and may be stored as metadata along with the streams.

Given a target optimal rate r calculated by media-aware congestion control and a recommended FEC percentage fₐ, the SVC stream rate r_{svc} may be determined as:

r_{svc}=rₘ,rₘ≦(1−fₐ)r<rₘ₊₁,0≦m≦M, (8)

where the set of rates r₀, . . . , rₘ, . . . , r_{M} denote available rate points for the streams. The rest of the optimal rate may then be padded with FEC packets:

r_{fec}=r−r_{svc}. (9)

This rate may be approximated when transmitting each video frame of n network packets, by adding k=└r_{fec}n/r┘ FEC packets.

Testing results were obtained when implementing embodiments of the invention where “ns−2” and its performance was evaluated in various simulation scenarios involving different network topology and video streams. Each scenario achieves a target utilization of γ=95% at the bottleneck link. Price update interval τ may be set at 10 ms and the price update scaling factor may be κ=0.01 for the illustrative examples. Rate update parameters may be fixed at η=4.0 and α=250 ms at end hosts for the illustrations. Droptail queues with a limit of 50 packets are further used for the following illustrations.

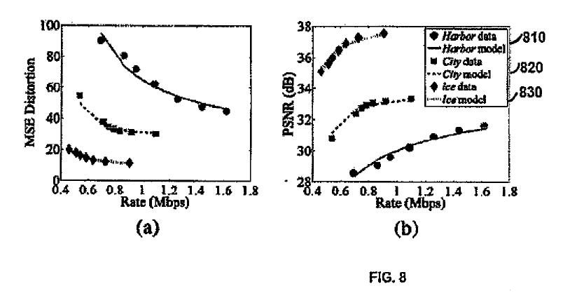

FIG. 8 illustrates the rate-distortion tradeoff for three 4CIF video sequences used in testing embodiments of the present invention: Harbor 810, City, 820 and Ice 830. They have spatial resolution of 704×576 pixels per frame, and temporal resolution of 30 frames per second. Each stream may be encoded using the H.264/SVC reference codec, with two quality layers and GOP length of 32 frames, corresponding to 6 temporal levels and 7 available rate points. At the sender, the video packets may be further segmented into network packets with a size of 1500 bytes, and reassembled at the receiver. At the receiver, an acknowledgement (ACK) packet may be sent upon receipt of every network packet. The empirical R-D points may be fitted to the parametric model of equation (1).

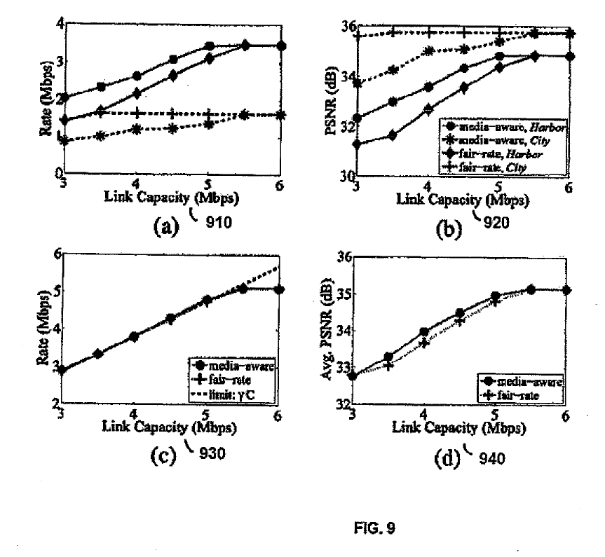

Testing Illustration #1—Heterogeneous Video Streams FIG. 9 illustrates testing results for embodiments of the present invention. This example first considers a simple scenario of two competing video streams, Harbor 810 and City 820, sharing a common bottleneck link. Performance of the proposed media-aware allocation scheme may be compared against a heuristic fair-rate allocation scheme, which allocates the same rate to both streams irrespective of their video content. In the case when the allocated rate for a given stream exceeds its maximum rate limit, the excess allocation may be shifted to other competing streams. In the testing, the round-trip-time for both streams may be set at 20 ms, and the link capacity varies from 3 Mbps to 6 Mbps. The two streams start at approximately the same time. The video stream rates and corresponding qualities may be calculated 10 seconds after allocation has converged, over a duration of 40 seconds.

Graph 910 illustrates a comparison of fair-rate and media-aware allocation in terms of average stream rate. Graph 920 illustrates a comparison of fair-rate and media-aware allocation in terms of corresponding video quality. Graph 930 illustrates a comparison of fair-rate and media-aware allocation in terms of total traffic rate at the bottleneck link. Graph 940 illustrates a comparison of fair-rate and media-aware allocation in terms of overall quality of both streams measured as PSNR of their average video distortion.

While both schemes lead to the same total rate over the bottleneck link, it can be observed that embodiments of the invention consistently allocate higher rate for the more demanding Harbor sequence by reducing rate and quality for the less complex City sequence. As a result, higher average video quality and lower quality gap between the two streams may be achieved compared to fair-rate allocation. As the link capacity increases beyond 5.5 Mbps, the bottleneck link can now accommodate maximum rate for both streams, therefore allocation results from both media-aware and fair-rate scheme become identical.

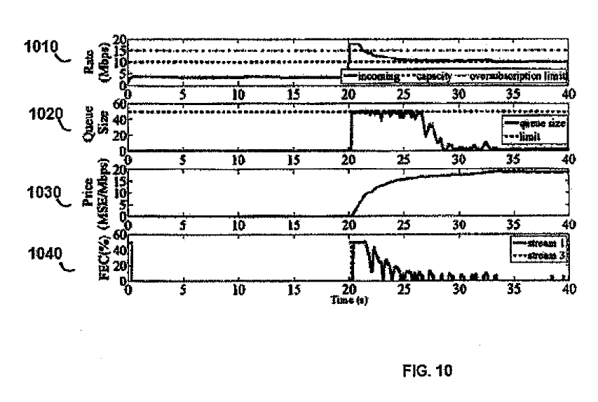

Testing Illustration #2—Transient Network Conditions FIG. 10 shows traces of arrival traffic rate at the bottleneck link 1010, dynamics of the queue size 1020 and congestion price 1030, together with the recommended FEC protection percentage 1040 calculated by the proposed adaptive FEC scheme for illustrated stream 1 and stream 3. In a stressful network condition: Stream 1 may exist in the network starting from time t=0 s, whereas four additional streams start at the same time t=20 s all at once. This may cause a sudden surge of arrival traffic at approximately twice the capacity. In the example, all streams have a round trip time of 40 ms and the same video content. The link capacity in the example is 10 Mbps and the queue limit is 50 packets. The adaptive FEC scheme may inject FEC packets into the video stream in response to steeply rising price after time t=20 s.

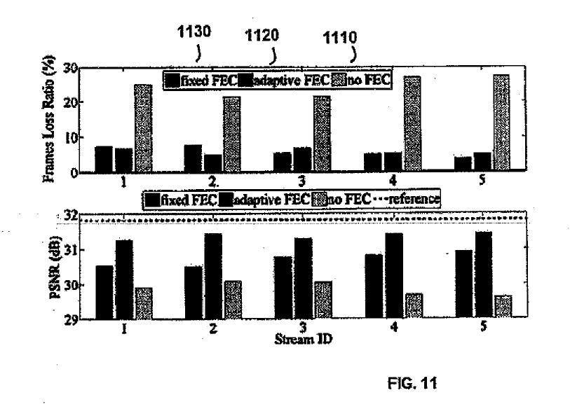

FIG. 11 further compares embodiments of the adaptive FEC scheme 1120 in the present invention against two other heuristics operating at extreme measures: 1) the no FEC scheme 1110 never injects FEC packets and 2) the fixed FEC scheme 1130 protects the video stream with a maximum amount of FEC percentage allowed, in our case, 50%. Specifically, FIG. 11 illustrates a comparison of average frame loss percentage due to transient congestion from time t=20 s to t=30 s and corresponding video quality in PSNR. Both adaptive 1120 and the fixed FEC 1130 schemes yield similar video traffic rate by backing off video source rate to accommodate FEC packets. However, the scheme without FEC 1100 operates at a video rate slightly below the optimal target rate calculated in embodiments of the invention.

It can be observed from FIG. 11 that the adaptive FEC scheme 1120 achieves the same level of protection as the fixed FEC scheme 1130 in terms of recovering lost video frames due to transient congestion. However, embodiments of the invention outperform both heuristics in terms of the average decoded video quality. The improvement over no FEC 1110 may be mainly due to lower frame loss ratio from FEC packet protection; the improvement over the fixed FEC scheme 1130 may be attributed to the fact that the embodiments of the invention can choose to stream at a higher video source rate for better quality at times when the network may not suffer congestion.

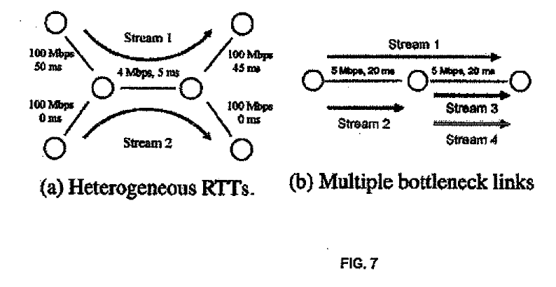

Testing Illustration #3—Streams with Heterogeneous RTT Embodiments of the invention also ensure unbiased allocation to streams experiencing heterogeneous round-trip-times (RTTs). FIG. 7 shows network simulation topologies for embodiments of the present invention. Specifically, FIG. 7 (a) shows a network topology for verifying unbiased allocation to streams experiencing heterogeneous RTTs. In this illustration, both streams bear the same video content, Harbor, but may be delivered over two paths with RTT of 200 ms and 10 ms, respectively. Bottleneck link capacity may be 4 Mbps.

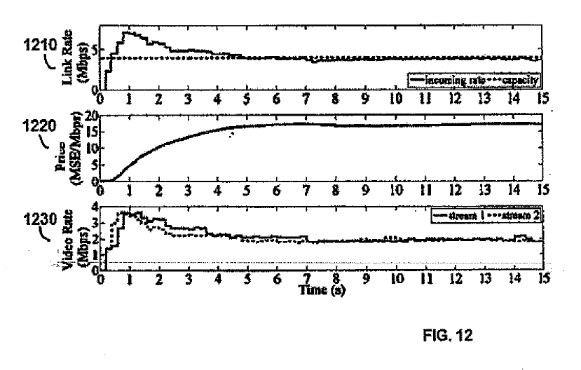

FIG. 12 illustrates traces of the total arrival traffic rate at the bottleneck link 1210, the dynamics of its congestion price 1220, and the corresponding allocated rates to the two streams sharing a 4 Mbps bottleneck link 1230 as operated on the topology shown in FIG. 7(a). The two stream start at the same time, and experience RTTs of 200 ms and 10 ms respectively. As shown in FIG. 12, it took the stream with longer RTT more time to converge due to delayed observation in congestion prices. However, both streams may converge to the same rate at equilibrium. Total arrival traffic rate 1210 at the bottleneck link also may settle at the prescribed target: 95% of link capacity.

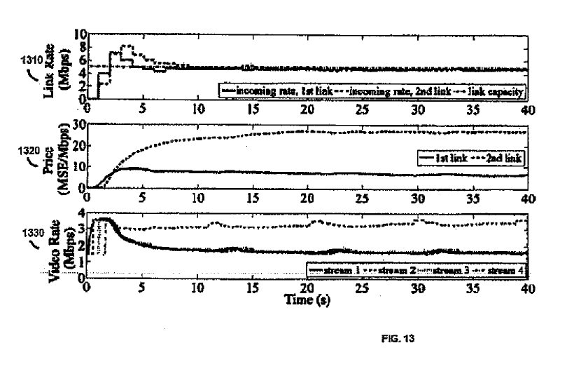

Testing Illustration #4—Multiple Bottleneck Links A more general network topology is shown in FIG. 7 (b), involving multiple bottleneck links. All four streams may bear the same video content. FIG. 13 shows traces of the total rate over each link 1310, the corresponding congestion prices 1320, and the allocated rate to each stream 1330. The congestion prices for both links may be non-zero, since the first link may be a bottleneck for Stream 2 and the second link may be the bottleneck for Streams 1, 3 and 4. As the price observed at the end host may be the maximum of all link prices along the path, the allocated rate for Stream 1 may be determined by the price of the second link. It therefore achieves the same rate as Stream 3 and 4, as expected. Note that in a conventional scheme relying on end-to-end observations, Stream 1 traversing multiple bottleneck links would have received a lower rate.

Components of the systems/devices described above can be implemented as part of networked, distributed, and/or other computer-implemented and communication environments. Moreover, the real-time video processing functionality can be used in conjunction with a desktop computer, laptop, smart phone, personal data assistant (PDA), ultra-mobile personal computer, and/or other computing or communication devices to provide conferencing data. Aspects of a real-time video processing system can be employed in a variety of computing/communication environments. For example, a real-time video conferencing system can include devices/systems having networking, security, and other communication components which are configured to provide communication and other functionality to other computing and/or communication devices.

While certain communication architectures are shown and described herein, other communication architectures and functionalities can be used. Additionally, functionality of various components can be also combined, further divided, expanded, etc. The various embodiments described herein can also be used with a number of applications, systems, and/or other devices. Certain components and functionalities can be implemented in hardware and/or software. While certain embodiments include software implementations, they are not so limited and also encompass hardware, or mixed hardware/software solutions. Accordingly, the embodiments and examples described herein are not intended to be limiting and other embodiments are available.

It should be appreciated that various embodiments of the present invention can be implemented (1) as a sequence of computer implemented acts or program modules running on a computing system and/or (2) as interconnected machine logic circuits or circuit modules within the computing system. The implementation is a matter of choice dependent on the performance requirements of a computing system implementing the invention. Accordingly, logical operations including related algorithms can be referred to variously as operations, structural devices, acts or modules. It will be recognized by one skilled in the art that these operations, structural devices, acts and modules may be implemented in software, firmware, special purpose digital logic, and any combination thereof without deviating from the spirit and scope of the present invention as recited within the claims set forth herein.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

Although the invention has been described in connection with various exemplary embodiments, those of ordinary skill in the art will understand that many modifications can be made thereto within the scope of the claims that follow. Accordingly, it is not intended that the scope of the invention in any way be limited by the above description, but instead be determined entirely by reference to the claims that follow.

All rights including copyrights in the code included herein are vested in and the property of the Applicant. The Applicant retains and reserves all rights in the code included herein, and grants permission to reproduce the material only in connection with reproduction of the granted patent and for no other purpose.

What is claimed is:

1. A method for providing media-aware congestion control for the transmission of video streams, the method comprising:
estimating congestion price information for one or more intelligent network nodes;
responding to the congestion price information by calculating optimal rates for one or more end hosts;
adapting the sending rates of the one or more end hosts according to the calculated optimal rates; and
determining an amount of FEC to be inserted into the video streams based on the congestion price information.
